(19) United States
(12) Patent Application Publication
(10) Pub. No.: US 2013/0121322 A1
(43) Pub. Date: May 16, 2013

(54) METHOD FOR ESTABLISHING DATA CONNECTIVITY BETWEEN A WIRELESS COMMUNICATION DEVICE AND A CORE NETWORK OVER AN IP ACCESS NETWORK, WIRELESS COMMUNICATION DEVICE AND COMMUNICATIN SYSTEM

(71) Applicant: Apostolis K. Salkintzis, Athens (GR)

(72) Inventor: Apostolis K. Salkintzis, Athens (GR)

(73) Assignee: MOTOROLA MOBILITY, INC., Libertyville, IL (US)

(21) Appl. No.: 13/293,374

(22) Filed: Nov. 10, 2011

(51) Int. Cl. H04W 92/00; H04W 12/06

(52) U.S. Cl. 370/338; 370/328

(57) ABSTRACT

A method and wireless communication device are provided that establish data connectivity between the wireless communication device and a core network over an IP access network. The wireless communication device receives a request to establish data connectivity over an IP access network and provides required connectivity parameters for establishing the data connectivity requested. The wireless communication device then sends a message to initiate an authentication procedure with the core network over the IP access network, receives an authentication request message and sends a response to the authentication request message, the response including the required connectivity parameters when the IP access network is determined to be a trusted IP access network. The wireless communication device uses a data connection between the core network and IP access network established with the required connectivity parameters and after the authentication procedure is completed for communication between the wireless communication device and the core network.

### FIELD OF THE INVENTION

This disclosure relates to a method for establishing data connectivity between a wireless communication device and a core network over an Internet Protocol, IP, access network. A wireless communication device and a communication system are also disclosed and claimed.

### BACKGROUND OF THE INVENTION

The Long Term Evolution (LTE) communication standard has been developed by the 3^{rd} Generation Partnership Project (3GPP) to provide improved end user experience with full mobility. LTE supports IP-based traffic and provides data connectivity to users via an Evolved Packet Core (EPC) network and a radio access network called the Evolved UMTS Terrestrial Radio Access Network (E-UTRAN).

The 3GPP working group SA2 has initiated a new work item description called ‘S2a Mobility based On GTP & WLAN access to EPC’ (SaMOG for short) which will (a) enable WLANs to be considered as trusted access networks that provide connectivity to the EPC and (b) provide GPRS Tunnelling Protocol (GTP) connectivity between the WLAN and EPC. The results of the corresponding study in 3GPP are documented in 3GPP Technical Report TR 23.852 (V0.4.0), the disclosure of which is incorporated herein by reference, and the considered architecture for a non-roaming trusted WLAN model is shown in FIG. 1.

A STa interface is used for authentication, authorization and accounting (AAA) with an AAA server 112, and is used to verify the identity of User Equipment (UE) and to authorize access to the 3GPP network core network (EPC) 104. An S2a interface between a trusted WLAN access network 102 and EPC 104 provides a QoS enabled bearer which tunnels all UE packets between the trusted WLAN access network 102 and a Packet Data Network Gateway (PDN-GW) 106, which is coupled to a data network 108, such as the Internet. In essence, when a UE 110 successfully attaches to the EPC 104 via the trusted WLAN access network 102 and S2a, the PDN-GW 106 becomes the UE's first-hop IP router.

When the UE 110 attempts to attach to a 3GPP network (EPC) 104 over a WLAN access network 102 that is considered trusted and the EPC 104 decides to use GTP over S2a for mobility management, the trusted WLAN access network 102 does not have a signaling protocol to allow the UE 110 to indicate to the EPC 104 its preferred connectivity data, such as:

Access Point Name (APN) data which indicates the service or packet data network the UE wants to connect to;

Packet Data Protocol/Packet Data Network (PDP/PDN) Type data which indicates the type of connectivity requested by the UE, such as, IPv4, IPv6, or both so that the EPC knows what IP address to assign to the UE 110;

Attach Type data which indicates whether the UE attach is for creating a new PDP/PDN connection (“initial attach”) or for handing over an existing PDP/PDN connection say from UTRAN to WLAN (“handover attach”).

Thus, when the UE 110 attaches to the EPC 104 over the trusted WLAN access network 102 and once authentication has been completed successfully, the EPC 104 establishes data connectivity for the UE 110 by creating a tunnel between the WLAN 102 and PDN-GW 106 according to default connectivity data preconfigured in the EPC 104. For example, a default APN is configured in a Home Subscriber Server (HSS) 114, which maintains subscription data for the UE 110. This default APN is used every time the UE 110 attempts to attach to EPC 104 via a trusted WLAN network and S2a interface. The use of a default APN as well as other default connectivity data introduces several limitations: for example, the UE is always connected to the same service or packet data network, the attach type is always considered as an “initial attach” so handing over existing PDP/PDN connections to trusted WLAN is not possible.

When a UE attaches to an EPC over a 3GPP access network such as an evolved High Rate Packet Data (eHRPD), a WiMAX access network, or an un-trusted WLAN network, in all of these cases, there are signaling means for the UE to communicate the above connectivity data to the network after the authentication procedure has been successfully completed (e.g., 24.008 signaling, IKEv2 signaling, DSMIPv6 signaling). In such attach cases, the signaling means therefore enables the connectivity data requested by the UE to be used to establish data connectivity instead of having to use preconfigured/default data as in the trusted WLAN case as discussed above.

This limitation of the EPC attach over trusted WLAN is illustrated in more detail with reference to FIG. 2, which shows the start of the EPC attach over trusted WLAN with GTP-S2a. Reference is also made to the elements of FIG. 1.

In step 3 of FIG. 2, the UE 110 transmits a so-called layer-3 attach trigger, which in most typical cases is an DHCPv4 request message requesting an IPv4 address and subnet mask, the address of a default router, etc. as is well known in the art. This request message triggers, in step 5 of FIG. 2, the WLAN access network 102 to initiate the creation of a GTP tunnel toward the PDN-GW 106. To create this tunnel, the WLAN access network 102 needs connectivity data such as APN data, a Handover Indication, PDP/PDN Type data. However, the UE 110 has currently no means for communicating the above connectivity data to the EPC 104 over WLAN access.

As discussed above, other non-3GPP access networks, such as eHRPD or WiMAX access networks or an un-trusted WLAN network, provide signaling means that facilitate communication of such connectivity data. For example, in an eHRPD access network, after successful authentication (after step 2 in FIG. 2), the UE 110 sends an eHRPD signaling message, called VSNCP Configure-Request, which includes the required connectivity data (see 3GPP2 X.S0057-0, E-UTRAN-eHRPD Connectivity and Interworking: Core Network Aspects, v1.0, April 2009). Also, in a 3GPP access such as UTRAN, GERAN or E-UTRAN, the connectivity data is included in the Attach Request message or in the PDN Connectivity Request message. In addition, when a UE attaches to an EPC over an un-trusted WLAN network, the UE uses IKEv2 signaling to establish an IPsec tunnel with the network (ePDG) and IKEv2 signaling has been extended to support the communication of connectivity data, such as APN. Furthermore, when a UE attaches to an EPC over a trusted WLAN with an S2c interface, the UE, once the authentication procedure has been completed successfully, uses DSMIPv6 signaling to request PDN connectivity and DSMIPv6 signaling has been extended to support the communication of connectivity data, such as APN. The UE determines that DSMIPv6 signaling should be used to attach to the EPC over a trusted WLAN access network based on configuration information or based on information received from the core network during the authentication procedure.

However, when attaching to an EPC over a trusted WLAN with an S2a interface, the UE lacks the appropriate means for signaling such connectivity data to the EPC. In this case, the UE does not exchange any signaling with the EPC after the authentication procedure has been completed successfully, so it cannot communicate the desired connectivity data, such as APN, attach type, etc.

As a result, when the UE 110 attaches to the EPC 104 over a trusted WLAN with S2a, the EPC 104 establishes connectivity for this UE 110 towards a “default APN”, which is pre-configured in the UE's subscription profile. This “default APN” is communicated to the WLAN access network 102 by the AAA server 112 in step 2 of FIG. 2. Also, the PDP/PDN Type is derived from pre-configured data in the subscription profile. Furthermore, it is assumed that the attach procedure is always an “initial attach” since there can be no explicit indication of whether it is initiated due to handover or not. All these assumptions and subscription-based preconfigured parameters render the attach procedure over trusted WLAN with S2a inefficient and inflexible and present considerable restrictions.

### BRIEF DESCRIPTION OF THE DRAWINGS

A method for establishing data connectivity between a wireless communication device and a core network over an Internet Protocol, IP, access network, a wireless communication device and a communication system in accordance with different aspects of the disclosure will now be described, by way of example only, with reference to the accompanying drawings in which:

FIG. 1 is a block schematic diagram of a communication system;

FIG. 2 is a diagram showing a message flow for the start of a known EPC attach procedure over trusted WLAN with GTP-S2a for the UE of FIG. 1;

FIG. 3 is a block schematic diagram of a wireless communication device in accordance with an example of an embodiment of the present disclosure;

FIG. 4 is a flow diagram showing an example method for establishing data connectivity between a wireless communication device and a core network over an IP access network in accordance with an embodiment of the disclosure; and

FIG. 5 is a diagram showing an example message flow for establishing data connectivity between a wireless communication device and a core network over an IP access network in accordance with an embodiment of the disclosure.

### DETAILED DESCRIPTION OF THE INVENTION

The present invention will be described with reference to a LTE communication system and establishing data connectivity between a wireless communication device and a core network of the LTE communication system (i.e., the Evolved Packet Core (EPC)) over a WLAN access network. It will however be appreciated that the present invention may apply to IP access networks other than WLAN, such as Bluetooth access networks, that do not having signaling protocols that would enable connectivity parameters to be sent from the wireless communication device to the core network as part of the attach procedure or which can support connection scenarios during which the UE is not normally involved in creating a communication tunnel between the UE and the core network. Furthermore, the present invention may apply to communication systems other than LTE communication systems such as GPRS or UMTS communication systems (assuming the PDN-GW element is substituted with a GGSN element). By describing the invention with respect to an LTE communication system and a WLAN access network with an S2a interface, it is not intended to limit the disclosure in any way.

The wireless communication device in accordance with the invention may be a portable or mobile telephone, a Personal Digital Assistant (PDA), a wireless video or multimedia device, a portable computer, a netbook, a tablet device, an embedded communication processor or similar wireless communication device. In the following description, the wireless communication device may be referred to generally as user equipment, UE, for illustrative purposes and it is not intended to limit the disclosure to any particular type of wireless communication device.

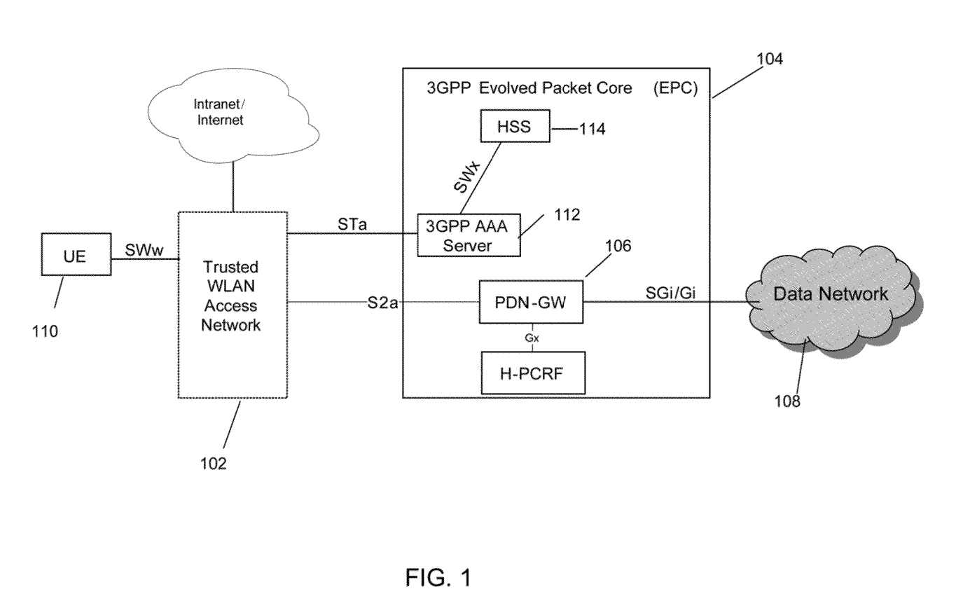

An example of a communication system in accordance with the disclosure is the communication system shown in FIG. 1. As discussed above with reference to FIG. 1, the communication system comprises a core network (the EPC 104 for a LTE communication system), a WLAN access network 102 communicably coupled to the EPC 104 (e.g., via interfaces STa and S2a) and a UE 110. The EPC 104 includes an AAA server 112, a Home Subscriber Server (HSS) 114, and a PDN-GW 106 which provides connectivity to external data networks 108, such as the Internet or a network that provides MMS services. The HSS 114 includes subscription-related information, such as subscriber profiles, performs authentication and authorization of the user (with the AAA server 112) and can provide information about the subscriber's location and IP information.

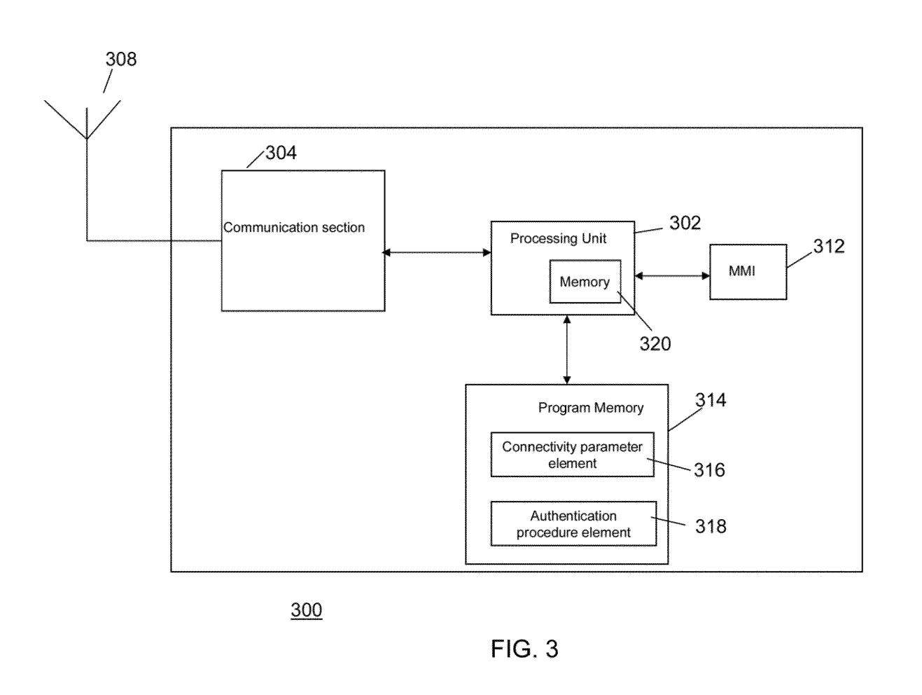

FIG. 3 is a block diagram of a wireless communication device 300, such as the UE 110 shown in FIG. 1, in accordance with an embodiment of the disclosure. As will be apparent to a skilled person, FIG. 3 shows only the main functional components of an exemplary wireless communication device 300 that are necessary for an understanding of the invention.

The wireless communication device 300 comprises a processing unit 302 for carrying out operational processing for the wireless communication device 300. The wireless communication device 300 also has a communication section 304 for providing wireless communication via a radio communication link with, for example, an eNodeB (not shown) of the E-UTRAN (not shown) of the LTE communication system or an access point or node (not shown) of the WLAN 102. The communication section 304 may comprise elements which are part of a LTE radio access interface of the wireless communication device and elements which are part of a WLAN radio access interface of the wireless communication device. The communication section 304 typically includes at least one antenna 308, a receiver (not shown) and a transmitter (not shown), at least one modulation/demodulation section (not shown), and at least one coding/decoding section (not shown), for example, as is be known to a skilled person and thus will not be described further herein. The communication section 304 may include one set of elements for the LTE radio access interface and one set of elements for the WLAN access interface or the interfaces may share elements. The communication section 304 is coupled to the processing unit 302.

The wireless communication device 300 also has a Man Machine Interface MMI 312, including elements such as a key pad, microphone, speaker, display screen, for providing an interface between the wireless communication device and the user of the wireless communication device. The MMI 312 is also coupled to the processing unit 302.

The processing unit 302 may be a single processor or may comprise two or more processors carrying out all processing required for the operation of the wireless communication device 300. The number of processors and the allocation of processing functions to the processing unit is a matter of design choice for a skilled person. The wireless communication device 300 also has a program memory 314 in which are stored programs containing processor instructions for operation of the wireless communication device by means of the processing unit 302. The programs may contain a number of different program elements or sub-routines containing processor instructions for a variety of different tasks, for example, for: communicating with the user via the MMI 312; processing signaling messages (e.g., paging signals) received from the E-UTRAN (not shown) and WLAN access network 102; and performing neighbouring coverage area measurements. Specific program elements stored in program memory 314 include a connectivity parameter element 316 for providing required connectivity parameters for establishing a requested data connectivity and an authentication procedure element 318 for trigger an authentication procedure for authenticating and authorizing the wireless communication device 300 for access to the EPC 104 over the WLAN access network 102. The operation of the connectivity parameter element 316 and the authentication procedure element 318 will be described in more detail below.

The wireless communication device 300 may further include a memory 320 for storing information. The memory 320 is shown in FIG. 3 as part of the processing unit 302 but may instead be separate.

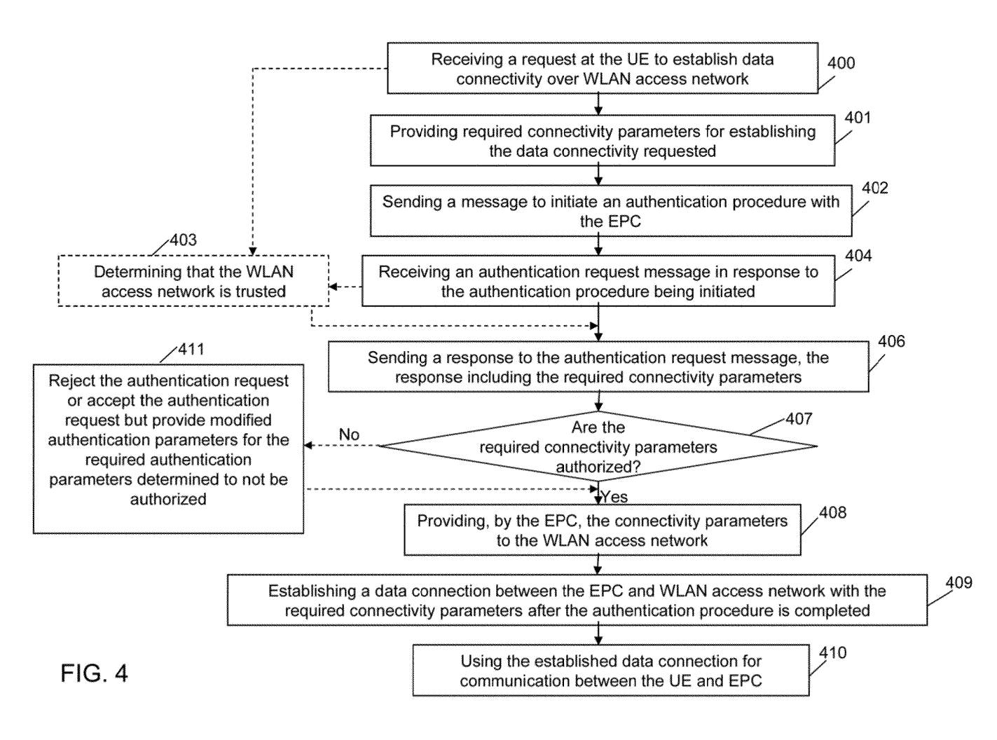

Referring now to FIG. 4, a flow diagram is provided that depicts steps of a method for establishing data connectivity between a wireless communication device 300 (such as UE 110 of FIG. 1) and a core network (such as EPC 104 of FIG. 1) over an IP access network (such as WLAN access network 102 of FIG. 1) in accordance with an example of an embodiment of the disclosure. The method shall be described with reference to the communication system of FIG. 1 by way of example; however, this is not intended to limit the invention to the particular types of networks shown and described with reference to FIG. 1.

In step 400, a request to establish data connectivity over an IP access network, such as WLAN access network 102, is received at the wireless communication device, that is, the UE 110. The request may be from a user of the UE 110 (e.g., user input via the MMI 312 of the UE), or may be from an application running on the UE 110. The request is initiated at the UE 110 and is received at the processing unit 302 of the UE. The UE 110 (e.g., by means of the processing unit 302) under the control of the connectivity parameter element 316 of the UE provides or determines the required connectivity parameters or data which are required for establishing the data connectivity requested, step 401. Thus, the required connectivity parameters include parameters needed for establishing a data connection according to the request but which are specified by the UE 110. The connectivity parameters are therefore required or preferred connectivity parameters specified by the UE 110. The connectivity parameters may include:

Access Point Name (APN) which indicates the service or packet data network the UE wants to connect to;

Packet Data Protocol or Packet Data Network (PDP/PDN) Type which indicates the type of connectivity requested by the UE, such as, IPv4, IPv6, or both so that the EPC knows what IP address to assign to the UE 110;

Attach Type which indicates whether the UE attach is for creating a new PDP/PDN connection (“initial attach”) or for handing over an existing PDP/PDN connection say from UTRAN to WLAN (“handover attach”);

Quality of Service (Qos) which indicates the level of service required or preferred by the user of the UE 110 for the data connectivity requested.

Other connectivity parameters may also be specified by the UE 110.

For example, if a user of the UE 110 or an application running on the UE 110 wants to access a web page or service on the Internet, the connectivity parameters may include an APN such as internet.vodafone.uk (which is preconfigured in the UE 110 as an APN that provides Internet access), a PDP/PDN Type such as IPv4v6 (if the UE supports both IPv4 and IPv6 addressing schemes) and an Attach Type such as “initial attach”.

The APN of the requested service/data network may be preconfigured in the UE 110.

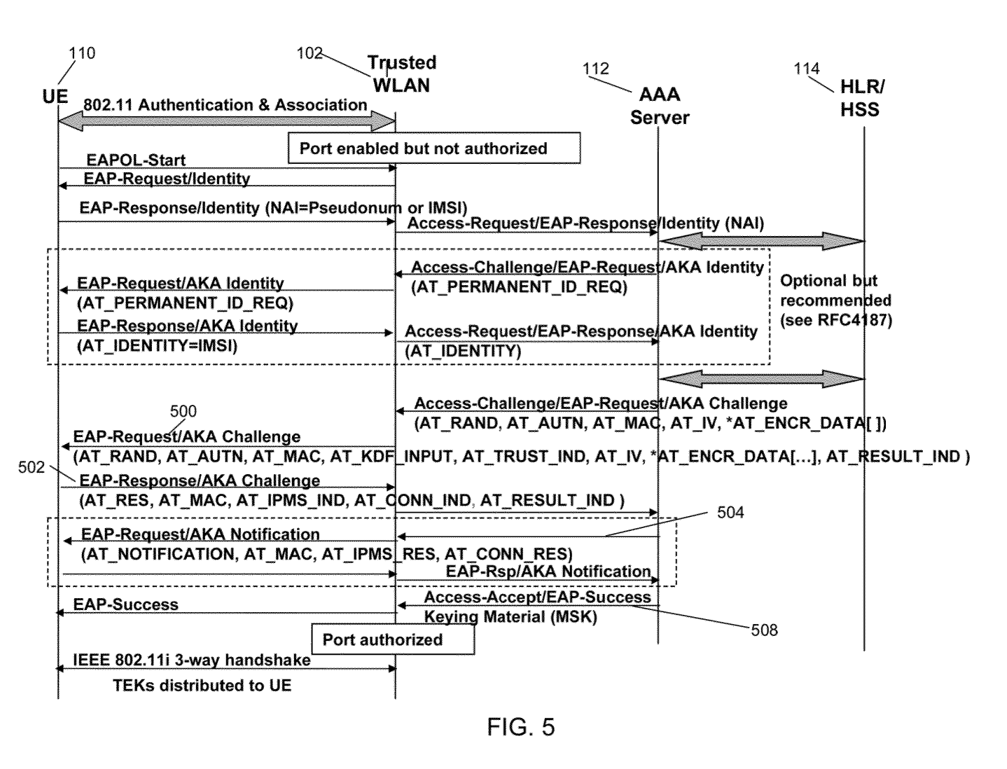

An authentication procedure is then initiated (typically initiated by the WLAN access network 102 with the EPC 104, step 402, in order to authenticate and authorize the UE 110 for access to the EPC 104 over the WLAN access network 102. The authentication procedure is triggered by the UE 110 (e.g., by means of the processing unit 302 of the UE under the control of the authentication procedure element 318 of the UE) in response to receiving the request to establish data connectivity. For example, the UE 110 may send a message (e.g., EAP-over-LAN (EAPOL) Start message) to the WLAN access network 102 which triggers the WLAN access network 102 to initiate the authentication procedure. The authentication procedure may be any type of Extensible Authentication Protocol (EAP). For example, the EAP-AKA procedure may be used and is described in more detail below with reference to FIG. 5 but other schemes may instead be used, such as EAP-SIM.

An authentication request message is received at the UE 110 in response to an authentication procedure being initiated, step 404.

The UE 110 (e.g., by means of the processing unit 302 of the UE), at step 406, sends a response to the authentication request message and the response includes the required connectivity parameters. At step 409, a data connection is established between the EPC 104 and the WLAN access network 102 with the required connectivity parameters after the authentication procedure is completed. In other words, once the authentication procedure has been completed successfully and the UE 110 has been authenticated and authorized for access to the EPC 104 via the WLAN access network 102 and with the required connectivity parameters, a data connection is established between the EPC 104 and the WLAN access network 102. The UE 110 (e.g., by means of the processing unit 302 of the UE) then uses the data connection between the EPC 104 and the WLAN access network 102 established with the required connectivity parameters after the authentication procedure is completed for communication between the UE 110 and EPC 104, step 410. In other words, the established data connection is used to transport all UE 110 data to/from the PDN-GW 106.

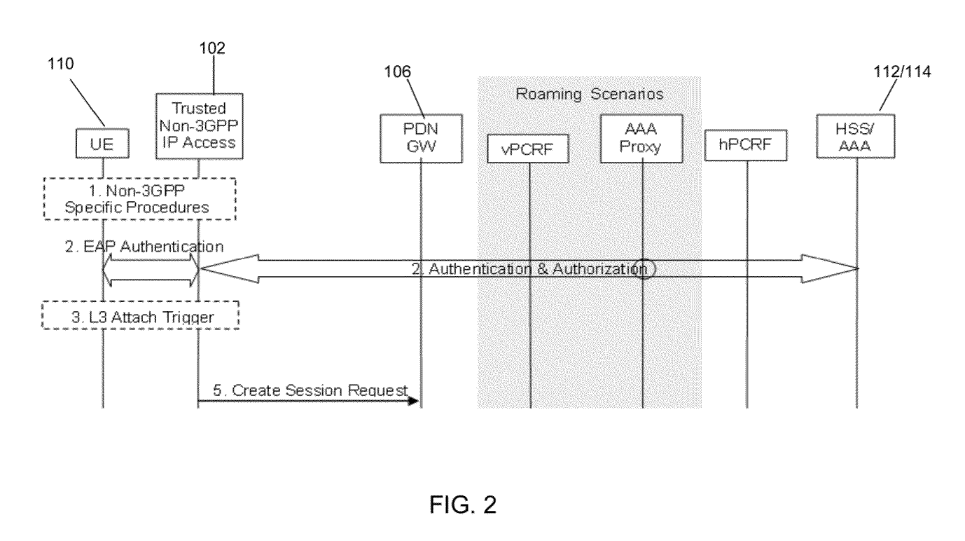

In an example arrangement, the connectivity parameters sent in the response to the authentication request message (step 406) are transported to the 3GPP AAA Server 112 in the EPC network 104 by means of regular transport mechanisms that facilitate the authentication procedure. The EPC 104, by means of the 3GPP AAA Server 112, authorizes the required connectivity parameters, e.g., it confirms that the UE 110 is allowed to use the required APN and PDP/PDN Type, step 407. If the authorization of the required connectivity parameters is successful (step 407), the EPC 104 via the 3GPP AAA Server 112 communicates these connectivity parameters to the WLAN access network 102, step 408. The WLAN access network 102 then uses the required connectivity parameters, which are now authorized, to establish a data connection between the EPC 104 and the WLAN access network 102, step 409. Thus, in this example arrangement the establishment of the data connection is initiated by the WLAN access network 102 (e.g., as shown in FIG. 2, step 5) and by using the required connectivity parameters that were received from the 3GPP AAA Server 112.

As described above, the UE 110 (e.g., by means of the processing unit 302 of the UE) then uses the data connection between the EPC 104 and the WLAN access network 102 established with the required connectivity parameters after the authentication procedure is completed for communication between the UE 110 and EPC 104, step 410.

In a case when the connectivity parameters are not authorized by the EPC 104 (via the 3GPP AAA Server 112), step 407, the EPC 104 may either (1) reject the authentication request with a suitable rejection message (e.g., “APN not authorized”) sent to the WLAN access network 102 and subsequently to the UE 110 or (2) accept the authentication request but provide modified connectivity parameters for those required connectivity parameters determined to be not authorized by the EPC 104 (e.g., use the default APN if the requested APN is not allowed, or allocate only an IPv4 address when the UE requested IPv4v6), step 411. For the latter case, the EPC 104 would notify the WLAN access network 102 of the modified connectivity parameters (and any of the required connectivity parameters determined to be authorized by the EPC 104) accepted by the EPC 104 and the authorized modified and required connectivity parameters would be used by the WLAN access network 102 to establish a data connection. The modified connectivity parameters are also communicated to the UE 110 so the UE knows that the EPC 104 has modified the required connectivity parameters requested by the UE 110. In response to receiving modified connectivity parameters or being notified that the required connectivity parameters have been modified, the UE 110 may take appropriate action (e.g., notify the user and/or the application that requested the data connection that the connectivity parameters have been modified).

In an example arrangement, the UE 110 (e.g., by means of the processing unit 302 of the UE) determines whether the WLAN access network 102 is a trusted IP access network, for example, by data pre-configured in the memory 320 or program memory 314 of the UE. This may occur prior to initiating the authentication procedure or during the authentication procedure and is represented in FIG. 4 by dotted box 403. An IP access network is designated a trusted network or a non-trusted network by the home network operator and the ‘trust’ status may be based on security features supported by the IP access network or other criteria. Information about the ‘trust’ status of an IP access network is provided to the EPC 104 (more specifically to the 3GPP AAA Server 112) and may also be provided to the UE 110, e.g., preconfigured at factory set up or subsequently. The UE 110 may therefore determine whether the WLAN access network 102 is a trusted IP access network based on information preconfigured in the UE 110 or the authentication request message received at the UE 110 from the EPC 104 at step 404 may include information from the EPC 104 indicating that the WLAN access network 102 is trusted. When the UE 110 determines that the WLAN access network 102 is trusted, a response to the authentication request message is sent, at step 406, and the response includes the required connectivity parameters.

As discussed above in the introduction, the current specifications support communication between the UE 110 and EPC 104 over trusted WLAN and an S2c interface. When the S2c interface is used and when the WLAN access network is determined to be trusted, the UE can use DSMIPv6 signaling to establish the data connection and include the required connectivity parameters inside the DSMIPv6 signaling once the authentication procedure has been completed successfully. In other words, the UE 110 communicates via DSMIPv6 signaling (or other mobility management protocol) to create a data connection once authentication has been completed.

In an example arrangement, the UE 110 may send the required connectivity parameters in response to the authentication request message when both the following conditions are met: 1) it is determined that the WLAN access network 102 is trusted and 2) when it is determined that the UE 110 is not to use or does not need to use “host based mobility” or a mobility management protocol (such as DSMIPv6 signaling or MIPv4 signaling). The UE 110 can learn if the WLAN access network is trusted by means of information (e.g., the AT_TRUST_IND attribute sent in step 500 of FIG. 5) included in the authentication request message sent by the EPC 104 or by means of prior configuration as discussed above. The UE 110 can learn if a “host based mobility” (e.g., DSMIPv6) is to be or needs to be used by means of information sent from the EPC 104 during the authentication procedure (e.g., the AT_IPMS_RES attribute sent in the message from the EPC in step 504 of FIG. 5) or by means of information pre-configured in the UE 110. When the UE 110 determines that a host based mobility protocol need not be used, the UE 110 is not involved in the creation of the data connection once the authentication procedure has been completed. The requirements of the UE 110 for the data connection can therefore be taken into account to establish the data connection by means of the required connectivity parameters sent by the UE 110 during the authentication procedure, but additional signaling to/from the UE (e.g., via a mobility management protocol) after authentication is not required to establish the data connection.

The term “host based mobility” is well known and used extensively in 3GPP and IETF specifications. The term “host” corresponds to the UE, so “host based mobility” corresponds to “UE based mobility”.

If the WLAN access network is determined to be untrusted, then the UE 110 attaches to the EPC 104 using IKEv2 signaling with the PDN-GW 106 to establish an IPsec tunnel with the network (ePDG) and IKEv2 signaling has been extended to support the communication of connectivity data, such as APN. This is discussed in the introduction.

In the case when the UE 110 wants an additional PDP/PDN connection over the WLAN access network 102, the UE can trigger a new authentication procedure in response to receiving a new request to establish data connectivity over the WLAN access network 102. The new request will result in new required connectivity parameters being provided by the UE 110 for establishing the data connectivity newly requested and the steps of receiving an authentication request message, sending a response and establishing data connectivity of FIG. 4 are repeated for the new request and new required connectivity parameters. In a typical example, the UE 110 can trigger a new authentication procedure by sending an EAP-over-LAN Start (EAPOL-Start) message. In turn, this will trigger the WLAN access network 102 to send an EAP Identity Request, which initiates the new EAP authentication procedure. As described above, the UE 110 will provide the new connectivity parameters to EPC 104 in the context of this new EAP authentication procedure.

For more details of the operation of the UE 110 in accordance with the disclosure, the operation will now be described with reference to FIG. 5, which shows an example message flow for establishing data connectivity between a wireless communication device (such as UE 110 of FIG. 1) and a core network (such as EPC 104 of FIG. 1) over an IP access network (such as WLAN access network 102 of FIG. 1) in accordance with an embodiment of the disclosure. The message flow shall be described with reference to the communication system of FIG. 1 by way of example; however, this is not intended to limit the invention to the particular types of networks shown and described with reference to FIG. 1.

FIG. 5 shows an EAP-AKA authentication method that complies with the applicable IETF standards ‘RFC4187: Extensible Authentication Protocol Method for 3rd Generation Authentication and Key Agreement (EAP-AKA), January 2006’ and ‘RFC5448: Improved Extensible Authentication Protocol Method for 3rd Generation Authentication and Key Agreement (EAP-AKA’), May 2009’ and 3GPP specification ‘3GPP TS 24.302 (v10.4.0), Access to the 3GPP Evolved Packet Core (EPC) via non-3GPP access networks; Stage 3 (Release 10), June 2011,’ the disclosures of which are incorporated herein by reference. In an example arrangement, this EAP-AKA authentication takes place when a UE 110 authenticates over a WLAN access network 102 that is considered trusted by the home 3GPP operator.

As shown in FIG. 5, the first AKA Challenge sent by the AAA server 112 in step 500 includes an AT_TRUST_IND attribute which informs the UE 110 of whether the WLAN is considered as a trusted or un-trusted access network (the encoding of this attribute is specified in TS 24.302, clause 8.2.3.1, the disclosure of which is incorporated herein by reference). This AKA Challenge sent by the AAA server 112 corresponds to the authentication request message sent to the UE 110 in step 404 of FIG. 4. In the response message (EAP-Response/AKA Challenge), step 502, the UE 110 may include an AT_IPMS_IND attribute that indicates the mobility management capabilities of the UE (see Table 1, which shows the contents of the AT_IPMS_IND attribute and which corresponds to Table 8.2.1.1 of TS 24.302).

TABLE 1
Contents of AT_IPMS_IND as specified in TS 24.302
Table 8.2.1.1: AT_IPMS_IND attribute
Octet 1 indicates the type of attribute as AT_IPMS_IND with a value of 137.
Octet 2 is the length of this attribute which shall be set to 1 as per IETF RFC 4187 [33]
Octet 3 and 4 is the value of this attribute. Octet 3 is reserved and shall be coded as zero.
Octet 4 shall be set as follows. All other values are reserved.

| 7 | 6 | 4 | 5 | 3 | 2 | 1 | 0 | Protocol Supported |
|---|---|---|---|---|---|---|---|---|
| 0 | 0 | 0 | 0 | 0 | 0 | 0 | 1 | DSMIPv6 only |
| 0 | 0 | 0 | 0 | 0 | 0 | 1 | 0 | NBM only |
| 0 | 0 | 0 | 0 | 0 | 0 | 1 | 1 | MIPv4 only |
| 0 | 0 | 0 | 0 | 0 | 1 | 0 | 0 | DSMIPv6 and NBM both supported |
| 0 | 0 | 0 | 0 | 0 | 1 | 0 | 1 | MIPv4 and NBM both supported |
| 0 | 0 | 0 | 0 | 0 | 1 | 1 | 1 | DSMIPv6 and NBM Supported; DSMIPv6 preferred |
| 0 | 0 | 0 | 0 | 0 | 1 | 1 | 1 | DSMIPv6 and NBM Supported; NBM preferred |
| 0 | 0 | 0 | 0 | 1 | 0 | 0 | 0 | MIPv4 and NBM supported; MIPv4 preferred |
| 0 | 0 | 0 | 0 | 1 | 0 | 0 | 1 | MIPv4 and NBM supported; NBM preferred |
| 0 | 0 | 0 | 0 | 1 | 0 | 1 | 0 | MIPv4 and DSMIPv6 supported; MIPv4 preferred |
| 0 | 0 | 0 | 0 | 1 | 0 | 1 | 1 | MIPv4 and DSMIPv6 supported; DSMIPv6 preferred |
| 0 | 0 | 0 | 0 | 1 | 1 | 0 | 0 | MIPv4, DSMIPv6 and NBM supported; MIPv4 preferred |
| 0 | 0 | 0 | 0 | 1 | 1 | 0 | 1 | MIPv4, DSMIPv6 and NBM supported; DSMIPv6 preferred |
| 0 | 0 | 0 | 0 | 1 | 1 | 1 | 0 | MIPv4, DSMIPv6 and NBM supported; NBM preferred |

This enables the network to know what type of mobility management mechanism can be used to support mobility management over the trusted WLAN access. The AT_IPMS_RES attribute indicates to the UE 110 the mobility management protocol selected by the AAA server 112, e.g., Host Base Mobility (DSMIPv6 or MIPv4) or Network Based Mobility (NBM). After the end of the authentication procedure of FIG. 5, the UE 110 behaves according to the mobility protocol indicated in the AT_IPMS_RES attribute or, if the AT_IPMS_RES attribute is not received from the core network, according to data pre-configured in the UE. For example, if the mobility protocol is DSMIPv6, the UE 110 will need to select a PDN-GW (or Home Agent), establish a security association with the selected PDN-GW and then perform a binding registration with the DSMIPv6 protocol. In this case, the UE 110 can include the required connectivity parameters into one or more DSMIPv6 messages. All these procedures are specified in 3GPP TS 24.303 (v10.3.0), Mobility management based on Dual-Stack Mobile IPv6; Stage 3 (Release 10), the disclosure of which is incorporated herein by reference. If on the other hand the mobility protocol in the AT_IPMS_RES attribute is NBM, the UE 110 does not need to use any mobility management protocol because all mobility is enabled by network-based procedures (i.e. with GTP).

In accordance with this disclosure, the UE 110 includes in the response sent at step 502 (which corresponds to the response sent in step 406 of FIG. 4) a new attribute, called AT_CONN_IND, which indicates the required or preferred connectivity parameters, such as the preferred APN, the PDP/PDN Type, the Attach Type, etc. As an example, the contents of the attribute AT_CONN_IND may be as shown in Table 2. The new attribute AT_CONN_IND is included when the WLAN access network is determined to be trusted and in an example arrangement, when no host based mobility protocol is selected.

TABLE 2
Example contents of AT_CONN_IND

| Connectivity parameter in | |
|---|---|
| AT_CONN_IND | Value |
| PDP/PDN Type | IPv4 or IPv6 or IPv4v6 |
| Attach Type | “Initial Attach” or “Handover |
| | Attach” |
| APN | Character string with the |
| | value of the requested APN. |
| QoS | Required QoS of the transport |
| | channel between the UE and |
| | PDN-GW. |
| Possibly other connectivity | . . . |
| parameters | |

When the AAA server 112 receives this attribute, the AAA server 112 confirms that the UE 110 is allowed to use the indicated APN and PDP/PDN Type, and then selects a suitable mobility management protocol to be used. In this example, the AAA server 112 selects NBM (network based mobility), which means that a GTP tunnel should be subsequently established (after the authentication procedure shown in FIG. 5 has been completed) between the trusted WLAN access network 102 and the PDN-GW. The AAA server 112 then selects a suitable PDN-GW (e.g., PDN-GW 106) and forwards the IP address or FQDN of the selected PDN-GW 106 to the trusted WLAN access network 102 along with the requested PDP/PDN Type, APN and Attach Type in step 508 (i.e., when the authentication is successful). After the end of the authentication procedure shown in FIG. 5, the trusted WLAN access network 102 creates a GTP tunnel to the selected PDN-GW GW 106 (see step 5 in FIG. 2) which includes the requested PDP/PDN Type, APN and Attach Type values received from the AAA server 112. In turn, the PDN-GW 106 validates the requested PDP/PDN Type, APN and Attach Type (by contacting the AAA server 112) and responds with a GTP response message (not shown in FIG. 5), which completes the creation of a GTP tunnel between the trusted WLAN access network 102 and the PDN-GW 106. This GTP tunnel is subsequently used to tunnel all UE packets to/from the PDN-GW 106 with a specific forwarding behavior (or with a specific quality of service). Apart from the PDP/PDN Type, APN and Attach Type, other connectivity parameters may be sent by the UE 110 in step 502, such as the required quality of service (QoS), as shown in Table 2.

In the case when the connectivity parameters are not authorized by the 3GPP AAA Server 112, as discussed above the EPC 104 may either (1) reject the authentication request with a suitable rejection message (e.g., “APN not authorized”) or (2) accept the authentication request but with modified required connectivity parameters (e.g., use the default APN if the requested APN is not allowed, or allocate only an IPv4 address when the UE requested IPv4v6). For the latter case, the EPC 104 could include a new attribute (e.g. AT_CONN_RES) in step 504 which indicates to the WLAN access network 102 the modified required connectivity parameters accepted by the EPC 104. The AT_CONN_RES could be encoded as shown in Table 2.

By facilitating the UE to provide, in response to a request for a data connection, the required connectivity parameters for the requested data connection and to send the required connectivity parameters for the requested data connection to the core network during authentication and in a response to an authentication request message, for example, as an EAP-AKA attribute sent by the UE to the core network, the present disclosure enables the UE to communicate its connectivity preferences to the core network and enables the network to establish connectivity for this UE over WLAN access based on such preferences. Thus, the UE can communicate the required or preferred connectivity parameters to the core network during the EPC attach procedure over a trusted WLAN network and thus, the communication tunnel (e.g., GTP connection) between the WLAN access network and the core network can be created using parameters specified by the UE. The core network therefore does not have to use preconfigured connectivity parameters which ensures a more efficient and flexible establishment of data connectivity.

More specifically, the invention proposes a new EAP-AKA attribute (called AT_CONN_IND) that could be specified by 3GPP, as was the case with other attributes like AT_IMPS_IND, and AT_TRUST_IND. Thus, when the UE responds to the AAA server's authentication challenge, the UE includes the new attribute (AT_CONN_IND) which contains the preferred connectivity data, such as APN, PDP/PDN Type, Attach Type, QoS, etc. and the core network uses the new attribute to establish connectivity for the UE over WLAN access based on such preferences. In case the UE wants an additional PDP/PDN connection over the trusted WLAN access network, it can trigger an EAP Re-authentication with new connectivity data. So, multiple PDP/PDN connections can be supported. Also, handover of PDP/PDN connections from 3GPP access to trusted WLAN with S2a can be supported too by requesting a PDP/PDN Type of “handover attach”. In this case, the PDN-GW will transfer all data exchanged on an existing PDP/PDN connection over 3GPP access to the PDP/PDN connection created (over S2a) between the WLAN access network and the PDN-GW.

In the foregoing specification, the invention has been described with reference to specific examples of embodiments of the invention. It will, however, be evident that various modifications and changes may be made therein without departing from the broader scope of the invention as set forth in the appended claims.

Some of the above embodiments, as applicable, may be implemented using a variety of different processing systems. For example, the Figures and the discussion thereof describe an exemplary architecture which is presented merely to provide a useful reference in discussing various aspects of the disclosure. Of course, the description of the architecture has been simplified for purposes of discussion, and it is just one of many different types of appropriate architectures that may be used in accordance with the disclosure. Those skilled in the art will recognize that the boundaries between program and system/device elements are merely illustrative and that alternative embodiments may merge elements or impose an alternate decomposition of functionality upon various elements.

1. A method for establishing data connectivity between a wireless communication device and a core network over an Internet Protocol, IP, access network, the method comprising at the wireless communication device:
receiving a request to establish data connectivity over an IP access network;
providing required connectivity parameters for establishing the data connectivity requested;
sending a message to initiate an authentication procedure with the core network over the IP access network;
receiving an authentication request message;
determining that the IP access network is a trusted IP access network;
sending a response to the authentication request message, the response including the required connectivity parameters when the IP access network is determined to be a trusted IP access network; and
using a data connection between the core network and IP access network established with the required connectivity parameters after the authentication procedure is completed for communication between the wireless communication device and the core network.

2. The method of claim 1, wherein the authentication request message includes information indicating that the IP access network is a trusted IP access network, wherein the determining includes determining that the IP access network is a trusted IP access network from the information included in the authentication request message.

3. The method of claim 1, wherein information indicating that the IP access network is a trusted IP access network is preconfigured in the wireless communication device.

4. The method of claim 1, wherein the connectivity parameters include at least one of the following: Access Point Name, APN, Packet Data Protocol/Packet Data Network, PDP/PDN, Type, Attach Type, Quality of Service, QoS.

5. The method of claim 1, wherein the authentication procedure is an EAP authentication procedure.

6. The method of claim 1, further comprising triggering a new authentication procedure in response to receiving a new request to establish data connectivity over the IP access network, providing new required connectivity parameters for establishing data connectivity as newly requested, the steps of receiving an authentication request message, sending a response and using a data connection being repeated for the new request and new required connectivity parameters.

7. The method of claim 1, wherein the IP access network is a WLAN access network communicably coupled to the core network via a S2a interface.

8. A method for establishing data connectivity between a wireless communication device and a core network over an Internet Protocol, IP, access network, the method comprising:
receiving at the wireless communication device a request to establish data connectivity over an IP access network;
providing at the wireless communication device required connectivity parameters for establishing the data connectivity requested;
sending by the wireless communication device a message to initiate an authentication procedure with the core network over the IP access network;
receiving an authentication request message;
determining that the IP access network is a trusted IP access network;
sending a response to the authentication request message, the response including the required connectivity parameters when the IP access network is determined to be a trusted IP access network;
establishing by the IP access network a data connection between the core network and the IP access network with the required connectivity parameters after the authentication procedure is completed; and
using the established data connection between the core network and IP access network for communication between the wireless communication device and the core network.

9. The method of claim 8, further comprising:
determining by the core network that the required connectivity parameters received from the wireless communication device are authorized; and
sending by the core network to the IP access network a message, the message including the required connectivity parameters authorized by the core network, the IP access network using the authorized required connectivity parameters for establishing the data connection.

10. The method of claim 8, further comprising:
determining by the core network that at least one of the required connectivity parameters received from the wireless communication device is not authorized; and
sending, in response to determining, by the core network to the IP access network a rejection message indicating that one or more of the required connectivity parameters is not authorized for use.

11. The method of claim 8, further comprising:
determining by the core network that at least one of the required connectivity parameters received from the wireless communication device is not authorized;
providing by the core network a modified connectivity parameter for the at least one of the required connectivity parameters determined to be not authorized; and
sending by the core network to the IP access network a message including the modified connectivity parameters and required connectivity parameters authorized by the core network, the IP access network using the authorized required and modified connectivity parameters for establishing the data connection.

12. The method of claim 8, wherein the authentication request message includes information indicating that the IP access network is a trusted IP access network, wherein the determining includes determining that the IP access network is a trusted IP access network from the information included in the authentication request message.

13. The method of claim 8, wherein the connectivity parameters include at least one of the following: Access Point Name, APN, Packet Data Protocol/Packet Data Network, PDP/PDN, Type, Attach Type, Quality of Service, QoS.

14. The method of claim 8, further comprising triggering a new authentication procedure in response to receiving a new request to establish data connectivity over the IP access network, providing new required connectivity parameters for establishing data connectivity as newly requested, the steps of receiving an authentication request message, sending a response and establishing data connectivity being repeated for the new request and new required connectivity parameters.

15. A wireless communication device, comprising:
a communication section for providing wireless communication; and
a processing unit coupled to the communication section, the processing unit being configured to:
receive a request to establish data connectivity between the wireless communication device and a core network over an Internet Protocol, IP, access network;
provide required connectivity parameters for establishing the data connectivity requested;
send a message to initiate an authentication procedure with the core network over the IP access network;
receive an authentication request message;
determine that the IP access network is a trusted IP access network;
send a response to the authentication request message, the response including the required connectivity parameters when the IP access network is determined to be a trusted IP access network; and
use a data connection between the core network and IP access network established with the required connectivity parameters after the authentication procedure is completed for communication between the wireless communication device and the core network.

16. The wireless communication device of claim 15, wherein the authentication request message includes information indicating that the IP access network is a trusted IP access network, wherein the processing unit is configured to determine that the IP access network is a trusted IP access network from the information included in the authentication request message.

17. The wireless communication device of claim 15, wherein the wireless communication device further includes a memory and wherein information indicating that the IP access network is a trusted IP access network is preconfigured in the memory of the wireless communication device.

18. The wireless communication device of claim 15, wherein the connectivity parameters include at least one of the following: Access Point Name, APN, Packet Data Protocol/Packet Data Network, PDP/PDN, Type, Attach Type, Quality of Service, QoS.

19. The wireless communication device of claim 15, wherein the authentication procedure is an EAP authentication procedure.

20. The wireless communication device of claim 15, wherein the processing unit is further configured to trigger a new authentication procedure in response to receiving a new request to establish data connectivity over the IP access network, and to provide new required connectivity parameters for establishing data connectivity as newly requested.

21. The wireless communication device of claim 15, wherein the IP access network is a WLAN access network communicably coupled to the core network via a S2a interface.

22. A communication system comprising a core network, an IP access network and a wireless communication device, the IP access network being communicably coupled to the core network for facilitating the establishment of a data connection between the wireless communication device and the core network over the IP access network,
the wireless communication device, comprising:
a communication section for providing wireless communication; and
a processing unit coupled to the communication section, the processing unit being configured to:
receive a request to establish data connectivity between the wireless communication device and the core network over an Internet Protocol, IP, access network;
provide required connectivity parameters for establishing the data connectivity requested;
send a message to initiate an authentication procedure with the core network over the IP access network;
receive an authentication request message;
determine that the IP access network is a trusted IP access network; and
send a response to the authentication request message, the response including the required connectivity parameters when the IP access network is determined to be a trusted IP access network,
wherein the IP access network is configured to establish a data connection between the core network and the IP access network with the required connectivity parameters after the authentication procedure is completed; and
wherein the processing unit of the wireless communication device being further configured to use the established data connection between the core network and IP access network for communication between the wireless communication device and the core network.

23. The communication system of claim 22, wherein the core network is configured to:
determine that the required connectivity parameters received from the wireless communication device are authorized; and
send to the IP access network a message, the message including the required connectivity parameters authorized by the core network, the IP access network being configured to use the authorized required connectivity parameters for establishing the data connection.

24. The communication system of claim 22, wherein the core network is configured to:
determine that at least one of the required connectivity parameters received from the wireless communication device is not authorized; and
send, in response to determining, to the IP access network a rejection message indicating that one or more of the required connectivity parameters is not authorized for use.

25. The communication system of claim 22, wherein the core network is configured to:
determine that at least one of the required connectivity parameters received from the wireless communication device is not authorized;
provide a modified connectivity parameter for the at least one of the required connectivity parameters determined to be not authorized; and
send to the IP access network a message including the modified connectivity parameters and required connectivity parameters authorized by the core network, the IP access network being arranged to use the authorized required and modified connectivity parameters for establishing the data connection.

26. The communication system of claim 22, wherein the authentication request message includes information indicating that the IP access network is a trusted IP access network, wherein the processing unit of the wireless communication device is configured to determine that the IP access network is a trusted IP access network from the information included in the authentication request message.

27. The communication system of claim 22, wherein the connectivity parameters include at least one of the following: Access Point Name, APN, Packet Data Protocol/Packet Data Network, PDP/PDN, Type, Attach Type, Quality of Service, QoS.

28. The communication system of claim 22, wherein the processing unit of the wireless communication device is further configured to trigger a new authentication procedure in response to receiving a new request to establish data connectivity over the IP access network, and to provide new required connectivity parameters for establishing data connectivity as newly requested.
